(19) United States
(12) Patent Application Publication
(10) Pub. No.: US 2020/0074549 A1
(43) Pub. Date: Mar. 5, 2020

(54) SYSTEMS AND METHODS FOR GENERATING COMMODITY INDEXES AND PRICE ASSESSMENTS

(71) Applicant: Barchart.com, Inc., Chicago, IL (US)

(72) Inventors: Mark Haraburda, Clarendon Hills, IL (US); Andrew Lowdon, Oak Park, IL (US); Keith Petersen, Chicago, IL (US); Eero Pikat, Chicago, IL (US); Xin Shi, Chicago, IL (US)

(21) Appl. No.: 16/559,615

(22) Filed: Sep. 3, 2019

Related U.S. Application Data
(60) Provisional application No. 62/725,375, filed on Aug. 31, 2018.

(51) Int. Cl. G06Q 40/04; G06Q 30/02; G06F 16/9538

(52) U.S. Cl. CPC G06Q 40/04; G06F 16/9538; G06Q 30/0201

(57) ABSTRACT

A system includes a market data system configured to provide market data for commodity transactions. The system includes a facility data system configured to provide capacity data for facilities used for the commodity transactions. The system includes a processing system communicatively coupled to the market data system and the facility data system, the processing system including one or more processors configured to execute instructions stored on computer-readable data storage hardware, the instructions causing the processing system to: receive the market data from the market data system and the capacity data from the facility data system; and generate price information based on the market data and the capacity data. The system includes a user system communicatively coupled to the processing system and configured to receive and process the price information for presentation to a user.

### CROSS-REFERENCE TO RELATED APPLICATIONS

This application claims benefit of, and priority to, U.S. Provisional Patent Application No. 62/725,375, filed Aug. 31, 2019, the contents of which are incorporated entirely herein by reference.

### BACKGROUND

### Field

The present disclosure generally relates to commodity transactions, and more particularly, to systems and methods for generating commodity indexes and price assessments based on such transactions.

### Description of Related Art

Commodities include primary agricultural products that can be bought and sold. Such agricultural products may include grains, such as corn, wheat, and soybeans. Transactions, including investments, involving agricultural products can be assessed by tracking prices for the agricultural products.

### SUMMARY

Aspects of the present disclosure provide systems and methods for generating price information that can be used to assess commodity transactions, including investments. The pricing information allows users to analyze historical trade performance and spot opportunities with new potential counterparties. Commodities may include grains, such as corn, wheat, and soybeans. To assess commodity transactions, example systems and methods can provide a family of data-driven, volume-weighted grain indexes and price assessments, which reflect continuous calculations of real time market values of physical grain within a series of rolling grain delivery periods. These calculations of market values may be distributed in two distinct series: (i) a price series representing the market clearing cash price for physical grain transactions, and (ii) a basis series representing the marketing clearing offset that grain buyers apply to futures related to the underlying commodity. Within each series, for instance, values are calculated and distributed relative to twelve rolling delivery windows, where each delivery window is one month long. To provide more accurate pricing information for a given geographical area, the grain indexes and price assessments can account for facility capacity, utilization, and throughput.

According to an example embodiment, a system includes a market data system configured to provide market data for commodity transactions. The system includes a facility data system configured to provide capacity data for facilities used for the commodity transactions. The system includes a processing system communicatively coupled to the market data system and the facility data system, the processing system including one or more processors configured to execute instructions stored on computer-readable data storage hardware, the instructions causing the processing system to: receive the market data from the market data system and the capacity data from the facility data system; and generate price information based on the market data and the capacity data. The system includes a user system communicatively coupled to the processing system and configured to receive and process the price information for presentation to a user.

### BRIEF DESCRIPTION OF DRAWINGS

FIG. 1 illustrates an example system architecture with a processing system that generates and delivers grain indexes and price assessments to a user system, according to aspects of the present disclosure.

FIG. 2 illustrates an example process for a cash bid data filter to identify potential erroneous data points and to enhance data quality for generating grain indexes and price assessments, according to aspects of the present disclosure.

FIG. 3A illustrates one of a plurality of example geographical areas j (e.g., counties) including elevators i, according to aspects of the present disclosure.

FIG. 3B illustrates one of a plurality of example geographical areas k (e.g., districts), according to aspects of the present disclosure.

FIG. 3C illustrates a hierarchy including different levels of geographical areas for generating corresponding grain indexes and price assessments, according to aspects of the present disclosure.

FIG. 4 illustrates an example process for adjusting capacity data for elevators i, according to aspects of the present disclosure.

FIG. 5 illustrates an example process for generating price assessments for geographical areas j (e.g., counties), according to aspects of the present disclosure.

FIG. 6 illustrates an example process for generating price assessments for the geographical areas k (e.g., districts), according to aspects of the present disclosure.

### DESCRIPTION

Aspects of the present disclosure provide systems and methods for generating price information that can be used to assess commodity transactions, including investments. The pricing information allows users to analyze historical trade performance and spot opportunities with new potential counterparties. Commodities may include grains, such as corn, wheat, and soybeans. To assess commodity transactions, example systems and methods can provide a family of data-driven, volume-weighted grain indexes and price assessments, which reflect continuous calculations of real time market values of physical grain within a series of rolling grain delivery periods. These calculations of market values may be distributed in two distinct series: (i) a price series representing the market clearing cash price for physical grain transactions, and (ii) a basis series representing the marketing clearing offset that grain buyers apply to futures related to the underlying commodity. Within each series, for instance, values are calculated and distributed relative to twelve rolling delivery windows, where each delivery window is one month long. To provide more accurate pricing information for a given geographical area, the grain indexes and price assessments can account for facility capacity, utilization, and throughput.

With the grain indexes and price assessments, for instance, a user's pricing and risk analysis systems are provided with valuable reference data, and a user can ensure that pricing aligns to fair values. Additionally, the grain indexes and price assessments provide forward curve information (e.g., twelve months), where the data can be easily used to plot curves historically and to identify seasonal patterns.

For a given grain commodity (e.g., corn, wheat, and soybeans), the family of grain indexes and price assessments may be grouped according to different geographic areas (e.g., counties, districts, states, regions, and the nation). For instance, the family of indexes and price assessments may include:
County grain assessments: Each county grain assessment is a price assessment of the real-time fair value price and basis for trading physical cash commodities within that geographic area. This value can serve as a benchmark for products traded within a given delivery period and may be used by both grain buyers and sellers as a reference to measure the competitiveness of their quotes and transactions.
District grain assessments: Each district grain assessment is representative of grain transactions within each specified crop reporting district and is used to identify trends relative to historical pricing behavior. This value can serve as a leading indicator of state grain index trends below. The United States Department of Agriculture (USDA) defines districts as groupings of counties in each state with similar climate and geographical attributes. Factors employed to define the groupings include, for instance, mean temperature, annual precipitation, and length of growing season.
State grain indexes: Each state grain index is representative of state wide grain transactions and is used to identify trends relative to historical pricing behavior. This value can serve as a leading indicator of regional grain index trends below.
Regional grain indexes: Each regional grain index is representative of grain transactions within defined main growing regions and is used to identify trends relative to historical pricing behavior. This value can serve as a leading indicator of national grain index trends below. Major growing zones in the United States may be divided into the following regions: Eastern, Western, Delta, and Others. The Eastern region is defined by Illinois, Indiana, Kentucky, Michigan, Ohio, and Wisconsin. The Western region is defined by Iowa, Kansas, Minnesota, Nebraska, North Dakota, and South Dakota. The Delta region is defined by Arkansas, Louisiana, Mississippi, Missouri, and Tennessee. The Others regions includes states not included in the Eastern, Western, or Delta regions.
National grain index: The national grain index is representative of grain transactions within the United States and is used to identify trends relative to historical pricing behavior.
   The indexes and price assessments described herein may involve over-the-counter (OTC) grain transactions, so that the family of indexes and price assessments may include county OTC grain assessments, district OTC grain assessments, etc.

Within each grouping, values may be distributed according to both a price series and a basis series. Within each series, values may be calculated and distributed relative to a twelve month rolling delivery method with each delivery window being one month long.

The grain indexes and price assessments are generated from market data and facility capacity, utilization, and throughput data. The market data may include cash grain bid and transaction data provided by a reliable, precise, and accurate data source, such as AgriCharts (Barchart, Chicago, Illinois). The facility capacity, utilization, and throughput data may be expressed in terms of grain elevator data (e.g., location and capacity of elevators for handling grain in a given geographic area). This grain elevator data may be collected and estimated according to any suitable process, but is preferably cross-referenced against third-party data sources, updated continuously, and reviewed for integrity on an ongoing basis.

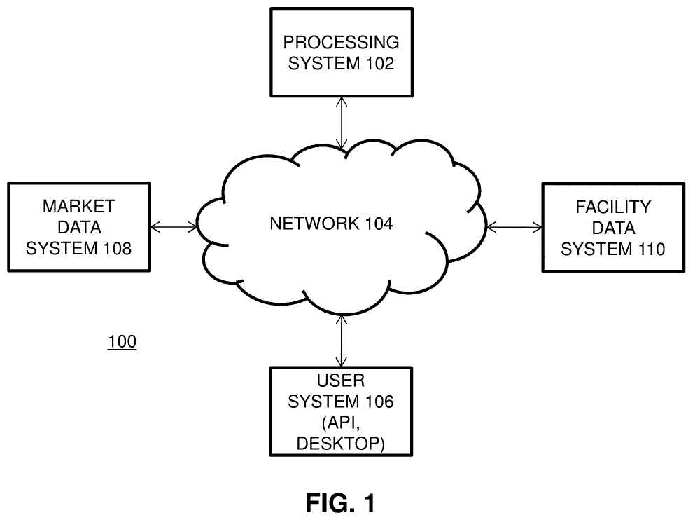

FIG. 1 illustrates an example system architecture 100 with a processing system 102 that generates and delivers data including the grain indexes and price assessments. The processing system 102 is communicatively coupled to, and can deliver the data to, a user system 106 via a network 104. The user system 106 may include a proprietary application or platform that employs an application programming interface (API) to receive the data from the processing system 102. Alternatively or additionally, the user system 106 may include a workstation that includes a desktop client (e.g., graphical user interface) that can receive and display the data from the processing system 102. In general, the indexes and assessments can be seamlessly integrated into a user's workflow for pricing and risk analysis. In some cases, any or all of the indexes and assessments can be conveniently delivered in one data call.

The example system architecture 100 also includes a market data system 108 and a facility data system 110 communicatively coupled to the processing system 102 via the network 104. The market data system 108 provides the processing system 102 with market data, such as cash grain bid and transaction data. Such market data may also include futures for the commodity. The market data system 108 may include any number of data sources to provide such data. The facility data system 110 provides the processing system 102 with facility capacity, utilization, and throughput data. As described herein, for instance, the facility data system 110 may provide data relating to grain elevators; however, other types of facilities may be evaluated to measure capacity, volume, etc., of commodity in transactions. In general, the data from the facility data system 110 allows the grain indexes and price assessments to be weighted according to capacity, volume, etc. In alternative scenarios, aspects of the market data system 108 and/or the facility data system 110 may be implemented on the processing system 102 with greater integration.

To enhance data integrity and quality, the processing system 100 can pass the market data from the source 114 through a restructuring process and a cleaning process. The data restructuring process filters and removes price outliers. For instance, data restructuring can be accomplished by grouping inbound data by delivery month and state.

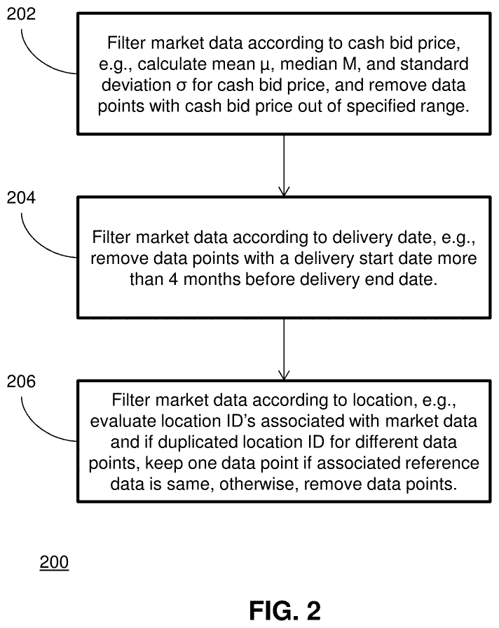

Meanwhile, in the cleaning process, the processing system 100 generates a cash bid data filter to identify potential erroneous data points, and to enhance data quality for index calculation. For instance, FIG. 2 illustrates a process 200 for the cash bid data filter.

At step 202, the process 200 filters grouped market data according to cash bid price. For instance, the process 200 may calculate a mean μ, a median M, and a standard deviation a for cash bid price and remove data points with cash bid price out of a specified range. In some approaches, the specified range is given by [μ−4Ω, μ+4Ω]∩[M−0.8, M+0.8].

At step 204, the process 200 filters the grouped market data according to delivery date. For instance, the process 200 may remove data points with a delivery start date more than 4 months before delivery end date.

At step 206, the process 200 filters the grouped market data according to location. For instance, the process 200 evaluates location identifications (ID's) associated with the grouped market data. If there is a duplicated location ID for different data points, the process 200 keeps one data point provided all associated reference data is the same. Otherwise, the process 200 removes all those data points.

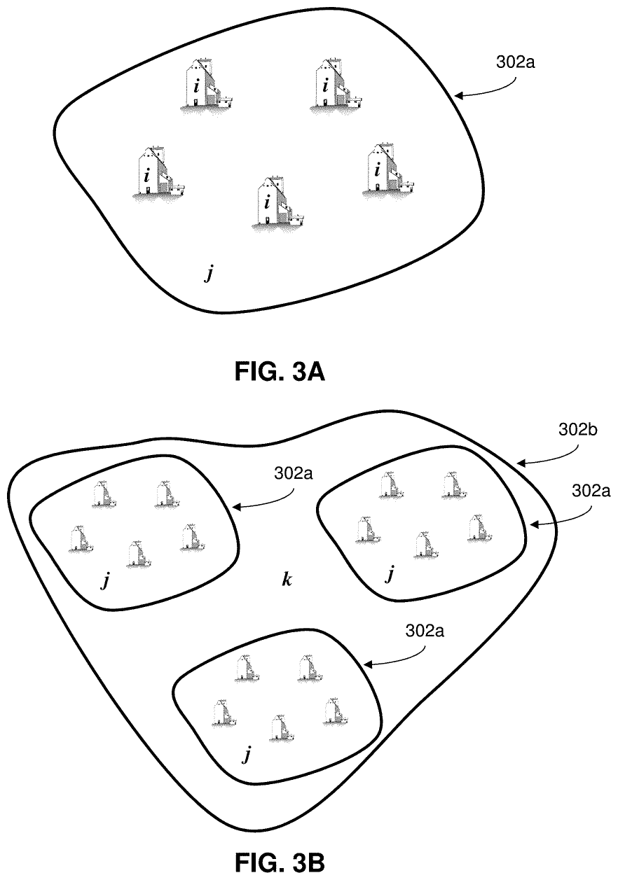

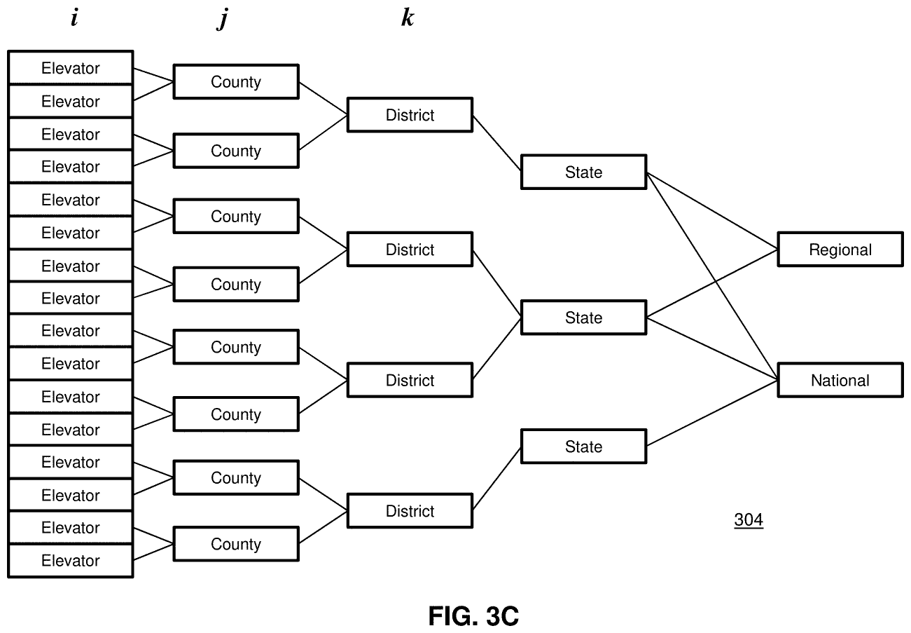

FIG. 3A illustrates one of a plurality of example geographical areas j. Each geographical area j is defined by a geographic boundary 302a and includes elevators i. In some scenarios, each geographical area j corresponds to a county and the geographic boundary 302a corresponds to the borders for the county. The elevators i are a part of a network of facilities that store, ship, sell, or buy a grain commodity. Facility capacity, utilization, and throughput data for the grain commodity can be determined for each geographical area j.

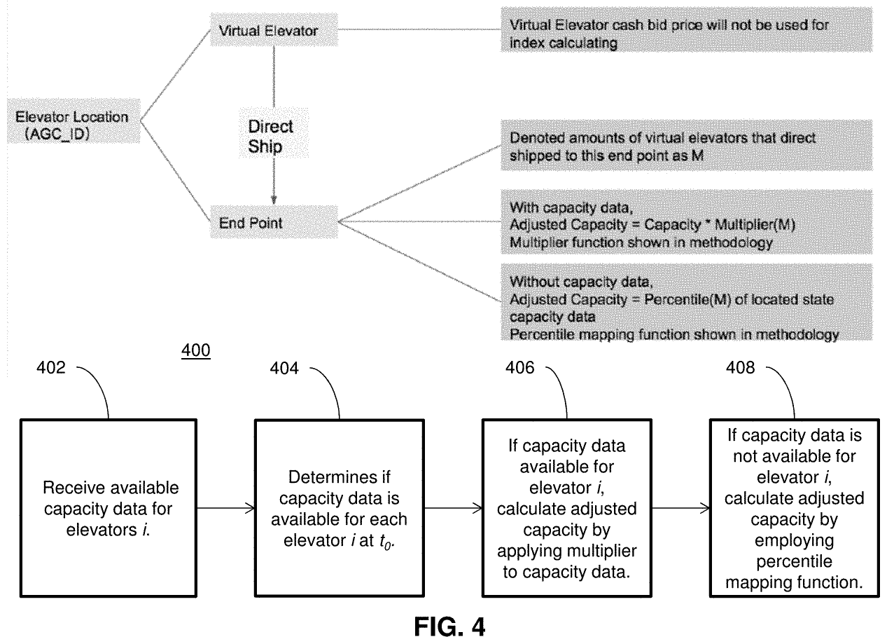

The grain elevator data system 110 can provide the processing system 102 with facility capacity, utilization, and throughput data in terms of elevators i. The grain elevator data system 110, for instance, may provide information associating each elevator i at a given location with one or more virtual elevators, which direct ship the commodity to the elevator i as an end point. FIG. 4 illustrates an example process 400 for adjusting capacity data for elevators i, which may be implemented with the system architecture 100.

At step 402, the process 400 receives and stores available capacity data for the elevators i. At step 404, the process 400 determines if capacity data is available for each elevator i at an index revision date t₀, e.g., an annual index revision date. Cᵢ^{t}^{₀} is the capacity of the elevator i at the date t₀ and remains constant until the next index revision is implemented. At step 406, if capacity data Cᵢ^{t}^{₀} is available for a particular elevator i, the process 400 calculates an adjusted capacity ACᵢ^{t} for the elevator i employing a multiplier function, where a multiplier Multiplierᵢ^{t}^{₀} is applied to the capacity data Cᵢ^{t}^{₀} according to equation (1):

ACᵢ^{t}^{₀}=Multiplierᵢ^{t}^{₀}*Cᵢ^{t}^{₀} (1)

Mᵢ^{t}^{₀} is the number of virtual elevators with a direct ship relationship to an elevator i at the date t₀ and remains constant until the next index revision is implemented. Using the number Mᵢ^{t}^{ₒ}, the multiplier Multiplierᵢ^{t}^{₀} is given by equation (2):

$${Multiplier}_{i}^{{t}_{0}} = \{ \begin{matrix}1.0 , & if {M}_{i}^{{t}_{0}} = 0 \\ 1.5 , & if {M}_{i}^{{t}_{0}} = 1 \\ 1.0 + {log}_{2}^{{M}_{i}^{{t}_{0}}} , & if {M}_{i}^{{t}_{0}} > 1\end{matrix} \qquad ( 2 )$$

The multiplier Multiplierᵢ^{t}^{₀} for the elevator i is calculated at the date tₒ and remains constant until the next index revision is implemented. Correspondingly, the adjusted capacity ACᵢ^{t}^{₀} is calculated for the elevator i at the date t₀ and remains constant until the next index revision is implemented.

At step 408, if the capacity data Cᵢ^{t}^{₀} is not available for a particular elevator i, the process 400 calculates an adjusted capacity ACᵢ^{t}^{₀} for the elevator i by employing a percentile mapping function based on a percentile Percentileᵢ^{t}^{₀} applied to a given state adjusted capacity AC_{State}^{t}^{₀} according to equation (3):

ACᵢ^{t}^{₀}=Percentileᵢ^{t}^{₀}(AC_{State}^{t}^{₀}) (3)

AC_{State}^{t}^{₀} is based on the array of the adjusted capacity data at the time t₀ for the state where the elevator is located. Using the number Mᵢ^{t}^{₀}, the percentile Percentileᵢ^{t}^{₀} is given by equation (4):

$${Percentile}_{i}^{{t}_{0}} = \{ \begin{matrix}25 , & if {M}_{i}^{{t}_{0}} = 0 \\ 75 + {log}_{2}^{Z} , & if 1 \leq {M}_{i}^{{t}_{0}} \leq 11 \\ 100 , & if {M}_{i}^{{t}_{0}} > 11\end{matrix} \qquad ( 4 )$$

The value for Percentileᵢ^{t}^{₀} is the percentile of the adjusted capacity of the elevator i in the state where elevator i is located at the date t₀ and remains constant until the next index revision is implemented.

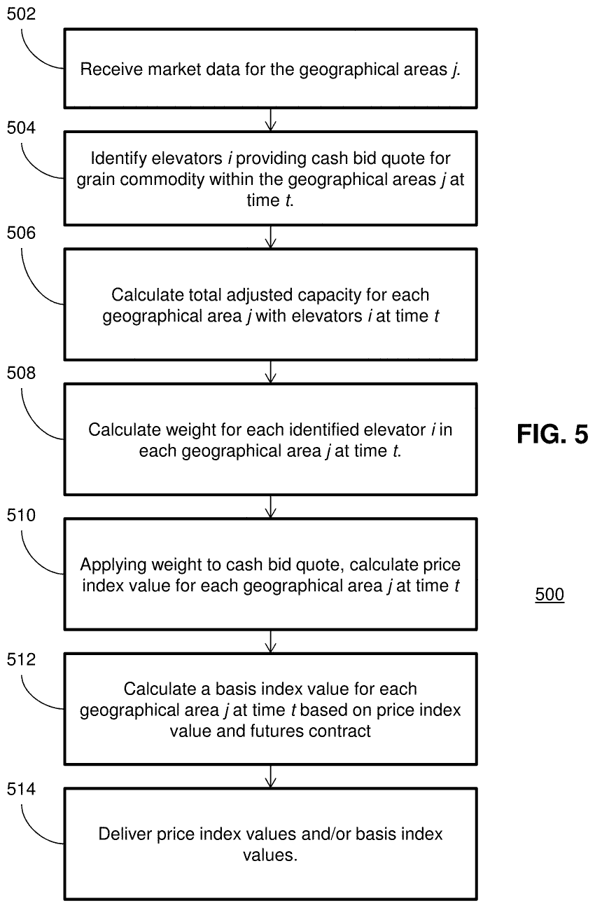

FIG. 5 illustrates an example process 500 for generating price assessments for the geographical areas j shown in FIG. 3A. The process 500 may be implemented with the system architecture 100 shown in FIG. 1. If the geographical areas j are counties, for instance, the process 500 generates county grain assessments based on the market data and facility capacity, utilization, and throughput data for the counties j.

At step 502, the process 500 receives market data for the geographical areas j. For instance, the processing system 102 receives market data from market data system 108 over the network 104. At step 504, the process 500 identifies the elevators i providing a cash bid quote for the grain commodity within the geographical areas j at a time t.

At step 506, the process 500 calculates a total adjusted capacity TCᵢ^{t} for each geographical area j with elevators i at the time t according to equation (5):

TCⱼ^{t}=Σᵢ₌₁ⁿ^{ⱼ}^{^{t}}ACᵢⱼ^{t}^{₀} (5)

The value for nⱼ^{t} of equals the total number of elevators i in a geographical area j at the time t, from which a cash bid quote is provided on the grain commodity during a delivery period included in the index delivery month. The adjusted capacity ACᵢ^{t}^{₀} is calculated for the elevator i in the geographical area j at the index revision date t₀ as described above. Thus, the value for TCⱼ^{t} is the total adjusted capacity of the elevators i in the geographical area j providing a cash bid quote at the time t.

At step 508, the process 500 calculates a weight Wᵢⱼ^{t} for each identified elevator i in each geographical area j at the time t according to equation (6):

$${W}_{ij}^{t} = \frac{A {C}_{ij}^{{t}_{0}}}{{TC}_{j}^{t}} \qquad ( 6 )$$

At step 510, using the weight Wᵢⱼ^{t}, the process 500 calculates a price index value Iⱼ^{t} for each geographical area j at the time t according to equation (7):

Iⱼ^{t}=Σᵢ₌₁ⁿW_{if}^{t}P_{if}^{t} (7)

The value Pᵢⱼ^{t} equals the cash bid quote associated with an identified elevator i in a geographical area j at time t. The price index value if represents the market clearing cash price for commodity transactions.

At step 512, the process 500 calculates a basis index value Bⱼ^{t} for each geographical area j at the time t according to equation (8):

Bⱼ^{t}Iⱼ^{t}−F^{t} (8)

The value for F^{t} equals the price of corresponding futures contract at the time t. The basis index value Bⱼ^{t} represents the marketing clearing offset that grain buyers apply to futures for the commodity.

At step 514, the process 500 provides price assessments for the geographical areas j by delivering the price index values Iⱼ^{t} and/or the basis index values Bⱼ^{t}. For instance, as shown in FIG. 1, the processing system 102 can send the price index values Iⱼ^{t} and/or the basis index values Bⱼ^{t} to the user system 106 via the network 104.

According to aspects of the present disclosure, systems and methods can derive assessments for certain data points where the underlying data is not sufficient to apply standard pricing approach for a particular calculation instance in the continuous price assessments. Corresponding scenarios are classified as missing delivery window or missing time series.

For instance, for a county with at least one, but not all, of twelve possible index values (for twelve rolling delivery windows, where each delivery window is one month long), a derivation process can simulate the missing delivery window associated with that county index. Where county j in district k has total N price index values for delivery months n₁, n₂, . . . , n_{N}, and missing M price index values for delivery months m₁, m₂, . . . , m_{M} at time t, a price index value for any missing delivery month m₁, I=1, 2, . . . , M, can be derived according to equation (9):

$${I}_{{jk}_{{m}_{l}}}^{t} = {UI}_{{jk}_{{m}_{l}}}^{t} + \frac{1}{N} {\sum }_{i = 1}^{N} ( {I}_{{jk}_{{n}_{i}}}^{t} - {UI}_{{jk}_{{n}_{i}}}^{t} ) \qquad ( 9 )$$

The values

$${UI}_{{jk}_{{m}_{l}}}^{t} and {UI}_{{jk}_{{n}_{i}}}^{t}$$

are the upper county level forward month mₗ, nᵢ price index for county j at time t, which may be from a district price index, a state price index, a regional price index, or a national price index as described herein depending on whether the price index has all price index values for the delivery month being used for the calculation. The values

$${I}_{{jk}_{{m}_{l}}}^{t} and {I}_{{jk}_{{n}_{i}}}^{t}$$

are the county forward month mₗ, nᵢ price index for county j at the time t.

For a county that is missing all twelve index values, the values can be derived using observations of price from previous days for the county as well as historical price relationships with other pricing locations. Upon a calculation event, the process generates a derivation candidate list, and if the county qualifies, applies a calculating process to simulate that county index. For instance, the missing time series may be derived according to equations (10) and (11):

ΔUIⱼₖ^{t}=UIⱼₖ^{t}−UIⱼₖ^{t-1} (10)

ΔIⱼₖ^{t}=Iⱼₖ^{t-1}−UIⱼₖ^{t} (11)

The value ΔUIⱼₖ^{t} is the difference between the higher level price index values for county j at times t and (t−1). The value Iⱼₖ^{t-1} is the price assessment for the county j in district k at the time (t−1), if available. Otherwise, the value Iⱼₖ^{t-1} can be replaced by a simulated price assessment for the county j in district k at the time (t−1). Iⱼₖ^{t} is a simulated price assessment for the county j in district k at the time t.

If underlying bid data has been missing for more than a specified number of days, e.g., 30 days, a geographic area can become ineligible for further price assessment. As such, assessments are no longer produced for geographic areas that likely no longer have a meaningful grain buying presence.

FIG. 3B illustrates one of a plurality of geographical areas k. Each geographical area k is defined by a second geographic boundary 302b and includes a set of geographical areas j with the elevators i. The geographic boundary 302b is employed to organize facilities and to accurately determine facility capacity, utilization, and throughput data for the grain commodity within the geographic boundary 302b.

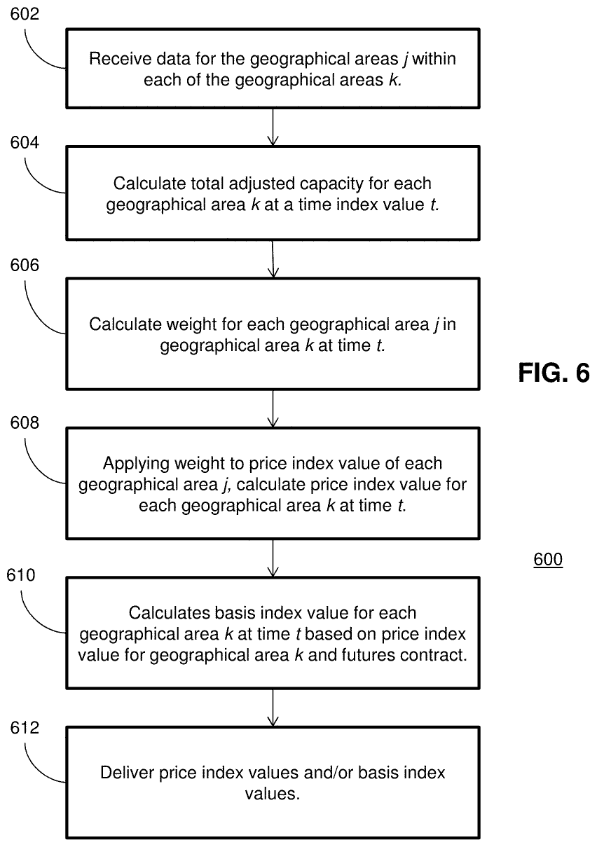

FIG. 6 illustrates an example process 600 for generating price assessments for the geographical areas k. If the geographical areas j are counties, the geographical areas k may be districts, and the process 600 generates district grain assessments based on the data for the districts k. The process 600, for instance, may also be implemented with the system architecture 100 shown in FIG. 1.

At step 602, the process 600 receives data for the geographical areas j within each of the geographical areas k, such as data from the process 500 above. At step 604, the process 600 calculates a total adjusted capacity [symbol] ₖ^{t} for each geographical area k at a time t according to equation (12):

$${k}_{t}^{} = {\sum }_{j = 1}^{{N}_{j}^{t}} ( {TC}_{jk}^{t} ) \qquad ( 12 )$$

The value Nⱼ^{t} is equal to the total number of geographical areas j in the geographical area k at the time t, where the geographical areas j are associated with price assessments as calculated, for instance, by the process 400 above. The value TCⱼₖ^{t} is the total adjusted capacity of the elevators i in each geographical area/ in the geographical area k providing a cash bid quote at the time t.

At step 606, the process 600 calculates a weight [symbol] ⱼₖ^{t} for each geographical area j in the geographical area k at the time t according to equation (13) by:

$${\breve{W}}_{jk}^{t} = \frac{{TC}_{jk}^{t}}{{k}_{t}^{}} \qquad ( 13 )$$

At step 608, the process 600 calculates a price index value [symbol] ₖ^{t} for each geographical area k at the time t according to equation (14):

$${k}_{t}^{} = {\sum }_{j = 1}^{{N}_{k}^{t}} {jk}_{t}^{} {I}_{jk}^{t} \qquad ( 14 )$$

The value Iⱼₖ^{t} equals the price index value of each geographical area j in the geographical area k at time t, as calculated, for instance, by the process 500 above. The price index value z,δₖ^{t} represents the market clearing cash price for commodity transactions.

At step 610, the process 600 calculates a basis index value [symbol] ₖ^{t} for each geographical area k at the time t according to equation (15):

[symbol]

ₖ^{t}= [symbol] ₖ^{t}−F^{t} (15)

The value [symbol] ₖ^{t} is the price index value of the geographical area k at time t as calculated in step 506, and F^{t} is the price of corresponding futures contract at the time t.

At step 612, the process 600 provides price assessments for the geographical areas k by delivering the price index values [symbol] ₖ^{t} and/or the basis index values [symbol] ₖ^{t}. For instance, as shown in FIG. 1, the processing system 102 can send the price index values [symbol] ₖ^{t} and/or the basis index values [symbol] ₖ^{t} to the user system 106 via the network 104.

As described above, systems and methods can derive assessments for certain data points where the underlying data associated is not sufficient to apply standard pricing approach for a particular calculation instance in continuous price assessments. Corresponding scenarios are classified as missing delivery window or missing time series.

For instance, for a district k with at least one, but not all, of twelve possible index values (for twelve rolling delivery windows, where each delivery window is one month long), a derivation process can simulate the missing delivery window associated with that district index. Where district k in state l has total N price index values for delivery months n₁, n₂, . . . , n_{N}, and missing M price index values for delivery months m₁, m₂, . . . , m_{M} at time t, a price index value for any missing delivery month mⱼ, j=1, 2, . . . , M, can be derived according to equation (16):

$${\breve{I}}_{{kl}_{{m}_{j}}}^{t} = {{kl}_{{m}_{j}}}_{t}^{} + \frac{1}{N} {\sum }_{i = 1}^{N} ( {\breve{I}}_{{kl}_{{n}_{i}}}^{t} {{kl}_{{n}_{i}}}_{t}^{} ) \qquad ( 16 )$$

The values

$${{kl}_{{m}_{j}}}_{t}^{} and {{kl}_{{n}_{i}}}_{t}^{}$$

are the higher level forward month mⱼ, nᵢ price index values for district k at time t, which may be from the higher level of a state price index, a regional price index, or a national price index as described herein depending on whether the price index has all price index values for the delivery month being used for the calculation. The values

$${{kl}_{{m}_{j}}}_{t}^{} and {{kl}_{{n}_{i}}}_{t}^{}$$

are the county forward month mⱼ, nᵢ price index values for district k in the state l at the time t.

For a district k that is missing all twelve index values, the values can be derived using observations of price from previous days for the district k as well as historical price relationships with other pricing locations. Upon a calculation event, the process generates a derivation candidate list, and if the county qualifies, applies a calculating process to simulate that county index. For instance, the missing time series may be derived according to equations (17) and (18):

Δ [symbol] ₖₗ^{t}= [symbol] ₖₗ^{t}− [symbol] ₖₗ^{t-1} (17)

[symbol]

ₖₗ^{t} [symbol] ₖₗ^{t-1}+Δ [symbol] ₖₗ^{t} (18)

The value Δ [symbol] ₖₗ^{t} is the difference between the higher level price index values for district k at times t and (t−1). The value [symbol] ₖₗ^{t-1} is the price assessment for the district k in state l at the time (t−1), if available. Otherwise, the value [symbol] ₖₗ^{t-1} can be replaced by a simulated price assessment for the district k in the state l at the time (t−1). [symbol] ₖₗ^{t} is a simulated price assessment for the district k in the state l at the time t.

If underlying bid data has been missing for more than a specified number of days, e.g., 30 days, a geographic area can become ineligible for further price assessment. As such, assessments are no longer produced for geographic areas that likely no longer have a meaningful grain buying presence.

FIG. 3C illustrates an example hierarchy 310 for a family of grain indexes and price assessments. At the lowest level, the hierarchy 310 includes a plurality of elevators i. The hierarchy 310 is further defined by levels of geographical areas. As described above, geographical areas may include counties, districts, states, regions, and nation. The family of grain indexes and price assessments may include any number of levels where the lower levels are generally defined by smaller geographical areas and the higher levels are generally defined by larger geographical areas that include the smaller geographical areas. The second level of the hierarchy 310 is defined by counties, each of which can include one or more of the elevators i. The geographical areas j described above may refer to such counties. As shown, an elevator i is associated with only one county. The third level of the hierarchy 310 is defined by districts, each of which can include one or more of the counties. The geographical areas k described above may be such districts. As shown, a given county is associated with only one district. The fourth level of the hierarchy 310 is defined by states, each of which can include one or more of the districts. As used herein, geographical areas l may refer to such states. As shown, a given district is associated with only one state. The fifth level of the hierarchy 310 is defined by regions, each of which includes one or more states as described above. As shown, a given state is associated with only one region. The sixth level of the hierarchy 310 is defined as the nation, which includes the states. Although FIG. 3C may show the relationship between particular geographical areas, it is understood that other geographical areas may be defined and included in a hierarchy for generating grain indexes and price assessments.

By considering varying levels of geographical areas, the grain indexes and price assessments can reveal trends that may only be visible when the grain indexes and price assessments are generated at a particular level. For instance, when generating price information for a smaller geographical area, such as a county, it may be more likely to identify the impact that a single large elevator i may have on pricing. Meanwhile, when generating price information for a larger geographical area, such as state or region, the impact of a single large elevator is less evident, but the impact of a factor such as soil type for a region or natural disaster may be more discernable.

As described above, the example process 600 can generate an index and price assessments for the geographical area k, which includes other geographical areas j. As shown in the hierarchy 310, the geographical areas k may be districts that include counties. Aspects of the example process 600 can be implemented to generate an index and price assessments for other (higher) levels of geographical areas in the hierarchy 310, namely states, regions, and the nation.

When the geographical areas l are states, equations (19)-(22) may be employed to generate corresponding price information for each state l at a time t:

$${l}_{t}^{} = {kl}_{t}^{} \qquad ( 19 )$$

The number \hat{N}ₖ^{t} is equal to the total number of districts in the state l at the time t having a corresponding district grain assessment. The value [symbol] ₖₗ^{t} is equal to the total adjusted capacity of elevators for the district k in the state l providing a quote at the time t, as calculated in the process 600 for instance. Thus, the value [symbol] ₗ^{t} is the total adjusted capacity for the state l.

$$( 20 )$$

The value [symbol] ₖₗ^{t} is the weight for the district k in the state l at the time t.

$${\hat{I}}_{l}^{t} = {\hat{W}}_{kl}^{t} {kl}_{t}^{} \qquad ( 21 )$$

The value [symbol] ₖₗ^{t} is the price index value of the district k in the state l at the time t corresponding to the district grain price assessment as determined above by the process 600, for instance. Accordingly, the value h provides the price index value for the state l at the time t.

\hat{B}ₗ^{t}−Îₗ^{t}−F^{t} (22)

F^{t} is the price of corresponding futures contract at the time t. Accordingly, the value \hat{B}ₗ^{t} provides the basis index value for the state l at the time t.

As described above, systems and methods can derive assessments for certain data points where the underlying data associated is not sufficient to apply standard pricing approach for a particular calculation instance in continuous price assessments. Corresponding scenarios are classified as missing delivery window or missing time series.

For instance, for a state l with at least one, but not all, of twelve possible index values (for twelve rolling delivery windows, where each delivery window is one month long), a derivation process can simulate the missing delivery window associated with that district index. Where state l has total N price index values for delivery months n₁, n₂, . . . , n_{N}, and missing M price index values for delivery months m₁, m₂, . . . , m_{M} at time t, a price index value for any missing delivery month mⱼ, j=1, 2, . . . , M, can be derived according to equation (23):

$${\hat{I}}_{{l}_{{m}_{j}}}^{t} = {{l}_{{m}_{j}}}_{t}^{} + \frac{1}{N} {\sum }_{i = 1}^{N} ( {\hat{I}}_{{l}_{{n}_{i}}}^{t} - {}_{{l}_{{n}_{i}}}^{t} ) \qquad ( 23 )$$

The values

$${{l}_{{m}_{j}}}_{t}^{} and {{l}_{{n}_{i}}}_{t}^{}$$

are the higher level forward month mⱼ, nᵢ price index values for state l at time t, which may be from the higher level of a regional price index or a national price index as described herein depending on whether the state l is loctaed in any major growing region. The values

$${\hat{I}}_{{l}_{{m}_{j}}}^{t} and {\hat{I}}_{{l}_{{n}_{i}}}^{t}$$

are the state forward month mⱼ, nᵢ price index values for state l in the state l at the time t.

For a state l that is missing all twelve index values, the values can be derived using observations of price from previous days for the state l as well as historical price relationships with other pricing locations. Upon a calculation event, the process generates a derivation candidate list, and if the county qualifies, applies a calculating process to simulate that state index. For instance, the missing time series may be derived according to equations (24) and (25):

Δ [symbol] ₗ^{t} [symbol] ₗ^{t}− [symbol] ₗ^{t-1} (24)

Îₗ^{t}=Îₗ^{t-1}+Δ [symbol] ₗ^{t} (25)

The value Δ [symbol] ₗ^{t} is the difference between the higher level price index values for state l at times t and (t−1). The value Îₗ^{t-1} is the price assessment for the state l at the time (t−1), if available. Otherwise, the value Îₗ^{t-1} can be replaced by a simulated price assessment for the state l at the time (t−1). Îₗ^{t} is a simulated price assessment for the state l at the time t.

When the geographical areas are regions, equations (26)-(29) may be employed to generate corresponding price information for each region at a time t:

[symbol]

^{t}=Σₗ₌₁^{t} [symbol] ^{t} (26)

The number m^{t} is equal to the total number of states in the region at the time t having a corresponding state grain index value. The value [symbol] ₗ^{t} is equal to the total adjusted capacity of elevators for the state l providing a quote at the time t, as calculated above for instance. Thus, the value [symbol] ^{t} provides the total adjusted capacity of elevators in the region quoted at the time t.

$${\tilde{W}}_{l}^{t} = \frac{ {t}^{}}{} \qquad ( 27 )$$

The value \tilde{W}ₗ^{t} is the weight for the state l in the region at the time t.

Ĩ^{t}=Σₜ₌₁^{m}^{^{t}}\tilde{W}ₗ^{t}Îₗ^{t} (28)

The value Îₗ^{t} is the price index value of the state l at the time t corresponding to the state grain price index as determined above, for instance. Accordingly, the value it provides the price index value for the region at the time t.

\tilde{B}^{t}=Ĩ^{t}−F^{t} (29)

F^{t} is the price of corresponding futures contract at the time t. Accordingly, the value \tilde{B}^{t} provides the basis index value for the region at the time t.

A front month weighting technique may be employed to calculate other forward month regional indexes. Front month delivery data typically has superior market coverage as well as capacity information that is more representative of the underlying market behavior. This technique assumes all facilities quoted on front month delivery for physical grain additionally quote other forward month delivery. Indexes calculated for forward month inherit the capacity weightings of front month index calculations.

For instance, where the regional grain front month price index is June 2017 June region index, equation (30) provides:

Ĩ_{JUN}^{t}=Σₗ₌₁^{m}^{_{JUN}}^{^{t}}\tilde{W}ₗ_{_{JUN}}^{t}Îₗ_{_{JUN}}^{t} (30)

The delivery month 2017 July (forward month 2) region index is calculated by using adjusted 2017 June weights adj\tilde{W}ₗ_{_{JUN}}^{t}, amount of states with state grain index m_{JUN}^{t}, and 2017 July state index value Îₗ_{_{JUN}}^{t} according to equation (31):

Ĩ_{JUN}^{t}=Σₗ₌₁^{m}^{^{JUN}}^{ₜ}adj\tilde{W}ₗ_{_{JUN}}^{t}Îₗ_{_{JUN}}^{t} (31)

If a number n^{t} states do not have a state forward month grain price index in those m_{JUN}^{t} number of states, their weights are set to zero and thus amplify the weights of other states proportional to its weights for calculating the regional forward month grain price index. Thus, according to equation (32):

$$adj {\tilde{W}}_{{l}_{JUN}}^{t} = \{ \begin{matrix}\frac{{\tilde{w}}_{JUN}^{t}}{1 - {\sum }_{i = 1}^{{n}^{t}} {\tilde{w}}_{JUN}^{t}} , & if state l is not in {n}^{t} states \\ 0 , & otherwise\end{matrix} \qquad ( 32 )$$

When the geographical area is national, equations (33)-(36) may be employed to generate the corresponding index at a time t:

T̅C̅^{t}Σₗ₌₁^{M}^{^{t}} [symbol] ₗ^{t} (33)

The number M^{t} is equal to the total number of states in the United States at the time t having a corresponding state grain index value. The value [symbol] ₗ^{t} is equal to the total adjusted capacity of elevators for the state l providing a quote at the time t, as calculated above for instance. Thus, the value T̅C̅^{t} provides the total adjusted capacity of elevators in the United States quoting at the time t.

$${\overline{W}}_{l}^{t} = \frac{{\overline{TC}}^{t}}{} \qquad ( 34 )$$

The value W̅ₗ^{t} is the weight for the state l among the United States at the time t.

Ī^{t}Σₗ₌₁^{M}^{^{t}}W̅ₗ^{t}Îₗ^{t} (35)

The value Îₗ^{t} is the price index value of the state l at the time t corresponding to the state grain price index as determined above, for instance. Accordingly, the value Ī^{t} provides the national price index value at the time t.

B̅^{t}=Ī^{t}−F^{t} (36)

F^{t} is the price of corresponding futures contract at the time t. Accordingly, the value B̅^{t} provides the basis index value for the United States at the time t.

A front month weighting technique may be employed to calculate forward month national indexes. As described above, front month delivery data can have superior market coverage as well as capacity information that is more representative of the underlying market behavior. This technique assumes all facilities quoted on front month delivery for physical grain additionally quote forward month delivery. Indexes calculated for forward month inherit the capacity weightings of front month index calculations.

For instance, where the national grain front month price index is 2017 June national index, equation (37) provides:

Ĩ_{JUN}^{t}=Σₗ₌₁^{M}^{_{JUN}}^{^{t}}W̅ₗ_{_{JUN}}^{t}Îₗ_{_{JUN}}^{t} (37)

The delivery month 2017 July (forward month 2) national index is calculated by using adjusted 2017 June weights adjW̅ₗ_{_{JUN}}^{t}, amount of states with state grain index M_{JUN}^{t}, and 2017 July state index value Îᵢ_{_{JUL}}^{t} according to equation (38):

Ī_{JUL}^{t}=Σₗ₌₁^{M}^{_{JUN}}^{^{t}}adjW̅ₗ_{_{JUN}}^{t}Îₗ_{_{JUL}}^{t} (38)

If a number N^{t} states do not have a state forward month grain price index in those M_{JUN}^{t} number of states, their weights are set to zero and thus amplify the weights of other states proportional to its weights for calculating the national forward month grain price index. Thus, according to equation (39):

$$adj {\overline{W}}_{{l}_{JUN}}^{t} = \{ \begin{matrix}\frac{{\overline{w}}_{{l}_{JUN}}^{t}}{1 - {\sum }_{i = 1}^{{n}^{t}} {\overline{w}}_{{i}_{JUN}}^{t}} & if state l is not in {n}^{t} states \\ 0 , & otherwise\end{matrix} \qquad ( 39 )$$

After generating a family of grain indexes and price assessments, systems and methods may perform ongoing review of the entire family. For instance, the capacity and direct ship relationships between all index constituents are reviewed for accuracy on a regular basis, and new locations may be onboarded daily.

As described above with reference to FIG. 1, the processing system 102 delivers data, including the grain indexes and price assessments, to the user system 106. The relationship between the processing system 102 and the user system 106 is not limited to a server-client relationship. Responsibilities for carrying out aspects of the present disclosure may be distributed between the processing system 102 and the user system 106 in varying degrees. Moreover, in some implementations, additional systems (e.g., computers) may be employed to carry out the features.

Some or all of the steps of the above-described and illustrated processes can be automated and/or guided by the processing system 102 and/or the user system 106. Generally, the processing system 102 and the user system 106 may be implemented as a combination of hardware and software elements. The hardware elements may include combinations of operatively coupled hardware components including microprocessors, logical circuitry, communication/networking ports, digital filters, memory, or logical circuitry. The processing system 102 and the user system 106 may be adapted to perform operations specified by a computer-executable code, which may be stored on a computer readable medium.

The processing system 102 and the user system 106 may be a programmable processing device, such as an conventional computer or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the example embodiments of the present disclosure, as is appreciated by those skilled in the computer and software arts. Appropriate software can be readily prepared by programmers of ordinary skill based on the teachings of the example embodiments, as is appreciated by those skilled in the software art. In addition, the devices and subsystems of the example embodiments can be implemented by the preparation of application-specific integrated circuits or by interconnecting an appropriate network of conventional component circuits, as is appreciated by those skilled in the electrical art(s). Thus, the example embodiments are not limited to any specific combination of hardware circuitry and/or software.

Stored on any one or on a combination of computer readable media, the example embodiments of the present disclosure may include software for controlling the devices and subsystems of the example embodiments, for driving the devices and subsystems of the example embodiments, for enabling the devices and subsystems of the example embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementations. Computer code devices of the example embodiments of the present disclosure can include any suitable interpretable or executable code mechanism, including but not limited to scripts, interpretable programs, dynamic link libraries (DLLs), Java classes and applets, complete executable programs, application program interfaces (APIs), and the like. Moreover, parts of the processing of the example embodiments of the present disclosure can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, or any other suitable medium from which a computer can read. These or similar storage deviced may be employed to store the market data by the market data system 108 and the facility data by the facility data system 110.

The network 104 can support communications between the systems (e.g., the processing system 102, the user system 106, the market data system 108, and the facility data system 110) communicatively coupled to the network 104. The network 104 as shown in FIG. 1 may represent one or more interconnected communication networks, such as or including the Internet, cellular networks, satellite networks, or the like. The network 104 is configured to communicate through a wired connection and/or wireless connection. The wired connection can include various wireline type communications such as Ethernet, fiber optic, or USB. The network 104 can also support wireless communications with any or all of 3G, 4G, and/or 5G cellular radio technologies (e.g., CDMA, EVDO, GSM, UMTS, LTE, WiMAX), as well as wireless local or personal area network technologies such as a Bluetooth, Zigbee, and WiFi (e.g., 802.11A, 802.11B, 802.11g). Other types of wireless access technologies can be supported as well. Communications can be compressed and decompressed using one or more compression and/or decompression algorithms and/or protocols such as, but not limited to, one or more lossless data compression algorithms and/or one or more lossy data compression algorithms. Communications can be made secure (e.g., be encoded or encrypted) and/or decrypted/decoded using one or more cryptographic protocols and/or algorithms.

The market data system 108 may receive and store the market data, such as cash grain bid and transaction data and futures data, from any number of sources, including commodity exchanges (e.g., Chicago Mercantile Exchange) and/or private market data providers (e.g., AgriCharts, Bloomberg and Thomson Reuters). The market data may be downloaded periodically to a database or be received through a live feed of data provided by the various sources. The market data stored on the database may be entirely or partially stored on any number of storage systems. The facility data system 110 may also receive and store the facility data from any number of sources, including commodity exchanges and/or private market data providers.

While the present disclosure has been described with reference to one or more particular embodiments, those skilled in the art will recognize that many changes may be made thereto without departing from the spirit and scope of the present disclosure. Each of these embodiments and obvious variations thereof is contemplated as falling within the spirit and scope of the present disclosure. It is also contemplated that additional embodiments according to aspects of the present disclosure may combine any number of features from any of the embodiments described herein. For instance, although the examples above may be described with reference to grain commodities, aspects of the present disclosure may be employed to assess prices for other types of commodities.

What is claimed is:

1. A system for generating price information for commodity transactions, comprising:
a market data system configured to provide market data for commodity transactions;
a facility data system configured to provide capacity data for facilities used for the commodity transactions;
a processing system communicatively coupled to the market data system and the facility data system, the processing system including one or more processors configured to execute instructions stored on computer-readable data storage hardware, the instructions causing the processing system to:
receive the market data from the market data system and the capacity data from the facility data system; and
generate price information based on the market data and the capacity data; and
a user system communicatively coupled to the processing system and configured to receive and process the price information for presentation to a user.
